(19) United States
(12) Patent Application Publication
(10) Pub. No.: US 2010/0130246 A1
(43) Pub. Date: May 27, 2010

(54) Method and Apparatus for Producing Hybrid Lenses

(75) Inventors: Ralf Biertümpfel, Mainz-Kastel (DE); Piotr Rosanka, Bünde (DE); Ulrike Stöhr, Mainz (DE); Bernd Wölfing, Mainz (DE); Wolfgang Semar, Mainz (DE); Jürgen Leib, Freising (DE)

Correspondence Address: DeMont & Breyer, LLC, 100 Commons Way, Ste. 250, Holmdel, NJ, 07733, US

(73) Assignee: SCHOTT AG, 55122 Mainz (DE)

(21) Appl. No.: 11/573,475

(22) PCT Filed: Aug. 5, 2005
(86) PCT No.: PCT/EP05/08507

§ 371 Date: Nov. 30, 2009

(30) Foreign Application Priority Data
Aug. 10, 2004 (DE) 10 2004 038 727.3

(51) Int. Cl. H04M 1/00; G02B 3/00; G01J 1/04; C03B 23/22

(52) U.S. Cl. 455/550.1; 359/642; 250/227.11; 65/37; 65/38

(57) ABSTRACT

The invention generally concerns optical systems and, in particular, a method and device for joining at least one first and one second optical element to an optical composite element, as well as an optical composite element itself. In order to produce optical systems having at least two optical elements more easily and more economically, the invention provides a method for joining at least one first and one second optical element, in which the first optical element contains a first glass or a crystalline material, the second optical element contains a second glass, and the first glass or the crystalline material has a transformation temperature Tg1 or a melting temperature that differs from the transformation temperature Tg2 of the second glass, and at least the glass of the second optical element is heated and brought into contact with the glass or with the crystalline material of the first optical element. The invention also relates to a device for carrying out the method and to an optical composite element that can be produced using the method.

The invention relates in general to optical systems and, in particular, to a method and an apparatus for connecting at least one first and one second optical element to a composite optical element.

In many technical applications, there is a growing need for powerful optical systems. Here, the spectrum covers, for example, laser technology, printing technology, solar technology, biochemistry, sensor technology, adaptive optical systems, optical computers, optical storage systems, digital cameras, two- and three-dimensional image reproduction, lithography and measurement techniques.

There is frequently a need for optical systems having a number of optical components in order to compensate aberrations or to implement specific beam profiles or complicated geometries.

The production of individual optical components by the molding of glass material is disclosed, for example, in U.S. Pat. No. 4,734,118, U.S. Pat. No. 4,854,958 or U.S. Pat. No. 4,969,944. When two optical components are joined to form an optical system, they are typically bonded to one another by means of a suitable adhesive layer, or are mounted in a common mount.

For example, JP 60205402 A discloses connecting an optical component made from glass to an optical component made from resin by means of an adhesive layer. Furthermore, for example, JP 07056006 A discloses applying a colored resin layer to an optical component made from glass.

As a rule, bonding of two optical components made from glass, and applying resin to glass require a cost intensive reworking in the form of, for example, unpolishing or edge grinding.

Furthermore, it is known from DE 43 38 969 C2 to apply complex diffractive structures to the surface of an optical component by etching. However, this method requires complicated process steps, and therefore causes high costs.

It is therefore the object of the invention to indicate a way of producing optical systems having at least two optical elements in a simpler and more cost effective fashion.

This object is achieved by means of the subject matter of the independent claims. Advantageous embodiments and developments are described in the respective subclaims.

Consequently, the invention serves the technical problem firstly by means of a method for connecting at least one first and one second optical element in the case of which the first optical element contains a first glass, the second optical element contains a second glass, and the first glass has a different transformation temperature Tg1 than the transformation temperature Tg2 of the second glass, and at least the glass of the second optical element is heated, and brought into contact with the glass of the first optical element.

The first step below is to define or clarify a few terms that are valid for the entire description and the patent claims. An optical element is understood as an at least partially transparent body that acts on penetrating light, for example by means of a parallel offset in the case of a plane parallel plate or filter plate, by means of a collecting or scattering action in the case of a collecting or scattering lens, by means of distributing the light to specific target zones in angular ranges or in specific, remotely situated surfaces in the case of free form surfaces or faceted surfaces, irrespective of whether this action is achieved by refraction or diffraction or by refraction and diffraction. The optical action can be based, in particular, on the refraction, diffraction and/or phase shifts of wavefronts of light waves.

A composite optical element, also denoted below as hybrid element, is understood as an optical element that has at least two volume regions that respectively have materials, in particular glasses, that differ from one another in at least one physical and/or chemical property.

The transformation temperature Tg denotes the transformation temperature in accordance with ISO 7884-8.

The method according to the invention preferably provides that the transformation temperature Tg1 of the first glass is higher than the transformation temperature Tg2 of the second glass.

The second glass, at least in the region that is brought into contact with the first glass, or the entire second optical element is preferably heated to a temperature that is higher than or equal to the transformation temperature Tg2 of the second glass, such that a deformation of the second glass is facilitated.

It is particularly preferred that the second glass, at least in the region that is brought into contact with the first glass, or the entire second optical element is heated to a temperature at which the viscosity of the second glass, at least in this region, is lower than or equal to a viscosity of approximately η<10¹⁰ dPa·s, in particular of η<10¹⁰ dPa·s. At such a viscosity of the second glass, the latter enters in a permanent bond with the first glass, which is stable even after cooling. Plastics, for example, are unable to exhibit such behavior, and so the use of glass is particularly advantageous.

The method advantageously provides that the heated region of the second glass, that has been brought into contact with the first glass, comprises that surface of the glass of the second optical element that touches the glass of the first optical element while being brought into contact.

In order to avoid stresses being produced in the glass upon connection with the optical elements, the method advantageously provides that the glass of the first optical element, at least in the region with which the glass of the second optical element is also brought into contact, or the entire first optical element is heated to a temperature that is higher than or equal to the transformation temperature Tg2 of the second glass.

It is particularly preferred that the glass of the first optical element, at least in the region with which the glass of the second optical element is brought into contact, or the entire first optical element is heated to a temperature that is higher than or equal to the transformation temperature Tg2 of the second glass or is lower than the transformation temperature Tg1 of the first glass. As a result of this, the glass of the second optical element can already be deformed, by the glass of the first optical element essentially retains its form.

The glass of the first and/or second optical element can be heated before or while the glasses are being brought into contact, or while the glasses are in contact. Heating while the glasses are in contact can preferably be performed by means of radiant heat, for example by microwave heating or by the short wave infrared method.

Furthermore, it is very advantageous to deform the second optical element during and/or after the bringing into contact by exerting a pressure on at least the second optical element. The pressure exerted is preferably between 0.01 and 20 N/mm².

As a result of the bringing into contact, possibly in conjunction with the exerted pressure, in the region in which the glass of the second optical element is brought into contact with the glass of the first optical element said glass of the second optical element substantially assumes the form of the first optical element, advantageously at least in a part of this region.

The first optical element can have different geometries for different applications. The method advantageously therefore provides that in the region in which the glass of the second optical element is brought into contact with the glass of the first optical element said glass of the second optical element assumes a substantially plane, convex or concave form, spherical, aspheric or faceted shape, a free form or a combination thereof, at least in a part of this region.

By using a suitable mold, it is possible, moreover, to deform the glass of the second optical element at least in a part of a further region that is situated substantially opposite the region in which the glass of the second optical element is brought into contact with the glass of the first optical element.

The method can therefore advantageously provide that the glass of the second optical element assumes a substantially plane, convex, concave, spherical, aspheric or faceted form, a free form or a combination thereof in this further region.

Furthermore, the method advantageously provides that in the further region the glass of the second optical element assumes a form whose surface includes diffractive elements that have the action of a collecting or scattering, spherical or aspheric lens.

The method provides that with particular advantage a third optical element that comprises a third glass with a transformation temperature Tg3 that is lower than the transformation temperature Tg2 of the second glass, be connected to the first and/or second optical element in the same way as was described above for connecting the second optical element to the first optical element.

The method also advantageously provides that further optical elements with a rising transformation temperature in each case be connected in the same way to the remaining optical elements.

Particularly good results are obtained when the transformation temperatures of two glasses to be connected differ from one another as strongly as possible. In order not to produce any stresses in the glasses, the two glasses are preferably heated to the same temperature. In the case of strongly differing transformation temperatures of the glasses, the viscosities of the glasses also generally strongly differ from one another upon heating. The glass with the higher transformation temperature is preferably not deformed upon execution of the method and has a viscosity of over 10¹³ dPa·s. Consequently, for this glass the heating temperature is preferably below the upper cooling temperature. In the event of a slight pressure action, the viscosity of the glass with the higher transformation temperature can also be below 10¹³ dPa·s without this glass being substantially deformed. The glass with the lower transformation temperature, which is to be deformed, preferably has a low a viscosity as possible at the heating temperature, its value particularly preferably being at most 10¹⁰ dPa·s, in particular at most 10⁹ dPa·s, since a sufficiently durable connection between the glasses is generally not achieved in the event of a higher viscosity.

The borofloat glasses B270, F2, LAF33, LASF43, BASF2, SF57, LASF46, LAK21, LAF32, LAF3, LASF45, LAF2, LASF44, BAF10, LAF21, LAK34, LASF41, LAK33a, LAK22, LASF31, SF2, N-FK5, SF4, LAK10, KF9, KZFS2, KFFS4, KZFS11, SF1, SF19, SF10, F2, SF8, LAF7, SF4, SF64, SF5, LAF36, BAF4, SF15, BASF64, BAF3, LASF40, BAF51, LAF35, SF56, BAF52, SF6, CD45, PSFn3, PBK50, GFK70, LaFK60, CSK12, CSK120, PSFn1, PBK40, CD120, VC81, GFK68, LaFK55, VC79, ZnSF8, VC78, VC89 and VC80, for example, can be used as glass with the higher transformation temperature.

The glasses N-SK56, N-PK52, N-PK53, KF9, KZFS2, KFFS4, KZFS11, SF1, SF19, SF10, F2, PG325, PG375, PSK50, PSK100, PSK11, CaFK95, PFK85, PFK80, CD45, PSFn3, PBK50, GFK70, LaFK60, CSK12, CSK120, PSFn1, PBK40, CD120, VC81, GFK68, LaFK55, VC79, ZnSF8, VC78, VC89, VC80 and Ba142, for example, can be used as glass with the lower transformation temperature.

The invention is not restricted to combinations of the said glasses, but are essentially all combinations of glasses that differ from one another in the transformation temperatures.

By way of example, in order to minimize aberrations the method advantageously provides that at least two of the glasses that are connected by means of the method differ from one another in their dispersion properties.

For applications of the optical elements in conjunction with electronic circuits, for example as a microlens array in optical image sensors, the method advantageously provides that at least two of the glasses differ from one another in their coefficients of thermal expansion, in particular the first glass having a small coefficient of thermal expansion that is preferably tuned to the coefficient of thermal expansion of silicon wafers.

Consequently, the method provides with particular advantage that a multiplicity of two optical elements, in particular in an ordered field (array) be brought into contact with the first optical element, the glass of the multiplicity of second optical elements in each case having the same transformation temperature Tg2.

It is therefore possible for example, to produce a lens array in which the first optical element is designed as a support glass with a low coefficient of thermal expansion tuned to that of a semiconductor wafer, and is therefore very suitable for wafer-level mounting, since only slight stresses build up between wafer and support glass in the event of temperature changes. Glasses with a low coefficient of thermal expansion can frequently not be blank pressed, or be so only poorly. Consequently, a glass with a relatively high coefficient of thermal expansion and which produces the optical function over its blank pressed contour is advantageously selected for the multiplicity of second optical elements.

Lens arrays, in particular microlens arrays for wafer level mounting can be produced in a particularly cost effective fashion with the aid of the method according to the invention.

Furthermore, it is advantageous for specific applications if at least one of the glasses is a fluorescent glass, with at least two of the glasses differ from one another in their chemical resistance to alkalis or acids, or that at least one of the glasses has a spectral transmission or coloration that differs from the spectral transmission or coloration of the further glasses.

The molding of the glasses is advantageously effected by pressing, precision pressing or blank pressing. In order to couple radiant heat in during the pressing operation, it is advantageous to use at least one pressing die that is transparent to this radiation.

Further advantageous embodiments of the method provide that there is applied to the glass of the first and/or the second optical element, at least in the region with which one or more further glasses are brought into contact, a layer that increases the adhesive strength, or one or more layers to be applied that have a refractive index that reduces the reflectivity.

Moreover, the method provides with particular advantage that at least one subregion of the glass of the second, third and/or a further optical element(s) be brought into contact with at least one holder part, and, if appropriate, that a pressure be exerted on the optical element or elements or the holder part such that at least one of the optical elements assumes the shape of the holder part at least partially. The holder part is preferably designed as a mounting ring that advantageously comprises a metal.

The method according to the invention can be used to produce optical hybrid or composite elements in the case of which two glasses are directly connected to one another without the need for an adhesive layer or similar. This greatly simplifies the production process, since it is generally possible to dispense with reworking.

The invention solves the technical problem furthermore by means of an apparatus for connecting at least one first and one second optical element, which can, in particular, be used to execute the abovedescribed method and comprises
a device for holding the first optical element,
a device for bringing together that is designed for the purpose of bringing at least the second optical element into contact with the first optical element, and
a device for heating at least one subregion of at least the second optical element.

The apparatus preferably comprises, moreover, a device for producing a pressure on at least the second optical element. This device can be designed, for example, as a press, in particular as a precision press or blank press.

In order to lend at least the second optical element a specific outer form, the apparatus particularly advantageously comprises a mold that, at least in a subregion of its surface, has a corresponding negative form of the optical element to be molded.

Thus, the mold can have a plane, convex or concave form, for example, at least in a subregion of its surface. Further examples of forms that advantageously have the mold at least in a subregion of its surface are negative forms of a substantially spherical, aspheric or faceted form.

In order to attain a predetermined radiation profile for special application purposes inside the optical element to be formed, the mold can also advantageously have a defined free form.

Furthermore, at least in a subregion of its surface the mold can particularly advantageously have a negative form at least of one diffractive element that has the action of a collecting, scattering, spherical or aspheric lens.

The device for heating advantageously comprises a device for coupling in radiant heat. In this embodiment, the mold is expediently designed in at least partially transparent fashion.

A particularly important field of application is the production of arrays of optical elements, in particular optical microelements. Consequently, the apparatus is designed with particular advantage so as to bring more than one second optical element preferably in an ordered field (array) into contact with the first optical element.

In a further preferred refinement, the apparatus comprises a device for coating the glass at least with the first and/or the second optical element at least in the region with which one or more further glasses are brought into contact.

This device for coating can, for example, be designed for applying an adhesion promotion layer to at least one optical element, for example by spraying on an epoxy resin. Again, the device can be designed for the purpose of applying a layer or a number of layers that have a refractive index that reduces the reflectivity.

The technical problem is also solved by means of a composite optical element that comprises at least
a first optical element that contains a first glass with the transformation temperature Tg1, and
a second optical element that contains a second glass with the transformation temperature Tg2,
the transformation temperature Tg1 having a higher value than the transformation temperature Tg2, and
the second glass being connected to the first glass along a common surface region with direct formation of a permanent bond to one another, in particular by means of the abovedescribed method.

The glass of the second optical element of the composite optical element preferably has substantially the negative form of the first optical element at least in a part of the surface region along which the latter is connected to the glass of the first optical element.

For more complex applications, the composite optical element can advantageously have further optical elements, the glass of the third optical element having a transformation temperature Tg3 that is below Tg2, and further optical elements respectively having glasses with, once more, lower transformation temperatures, and the glass of the respective further optical element being connected directly along a common surface region with the formation of a glass connection to at least one further glass with a higher transformation temperature.

Depending on the intended application, at least one optical element of the composite optical element can have, at least in a subregion, a substantially plane, convex, concave, spherical, aspheric or faceted form, a free form or a combination thereof.

The surface of at least one optical element of the composite optical element particularly advantageously includes diffractive elements that have the action of a collecting, scattering, spherical or aspheric lens, or that act in a fashion which is beam splitting, beam shaping, such as to vary the beam profile, athermal or achromatic, or have some other optical action and/or function.

The composite optical element expediently comprises at least two glasses, the first glass being selected from the group of borofloat glasses, B270, F2, LAF33, LASF43, BASF2, SF57, LASF46, LAK21, LAF32, LAF3, LASF45, LAF2, LASF44, BAF10, LAF21, LAK34, LASF41, LAK33a, LAK22, LASF31, SF2, N-FK5, SF4, LAK10, KF9, KZFS2, KFFS4, KZFS11, SF1, SF19, SF10, F2, SF8, LAF7, SF4, SF64, SF5, LAF36, BAF4, SF15, BASF64, BAF3, LASF40, BAF51, LAF35, SF56, BAF52, SF6, CD45, PSFn3, PBK50, GFK70, LaFK60, CSK12, CSK120, PSFn1, PBK40, CD120, VC81, GFK68, LaFK55, VC79, ZnSF8, VC78, VC89 and VC80, and the second glass is selected from the group of glasses N-SK56, N-PK52, N-PK53, KF9, KZFS2, KFFS4, KZFS11, SF1, SF19, SF10, F2, PG325, PG375, PSK50, PSK100, PSK11, CaFK95, PFK85, PFK80, CD45, PSFn3, PBK50, GFK70, LaFK60, CSK12, CSK120, PSFn1, PBK40, CD120, VC81, GFK68, LaFK55, VC79, ZnSF8, VC78, VC89, VC80 and Ba142.

The composite optical element advantageously comprises at least two glasses with different dispersion properties, the composite element preferably being designed so as to minimize chromatic aberrations.

The composite optical element further particularly advantageously comprises a lens system or a lens sequence that is suitable for correcting spherical aberrations, astigmatism and/or coma, or for contributing to their correction in the overall system.

In a preferred refinement, the composite optical element comprises at least two glasses with different coefficients of thermal expansion of which one preferably substantially corresponds to the semiconductor wafer, for example an Si, GaAs or GaN wafer. In this refinement, the composite optical element is particularly well suited to wafer level packaging.

The composite optical element further advantageously comprises at least one fluorescent glass, at least two glasses that differ from one another in their chemical resistance to alkalis or acids, or at least one glass that has a spectral transmission or coloration that differs from the spectral transmission or coloration of the other glasses. For example, the composite optical element can comprise a filter glass for filtering infrared, ultraviolet or visible electromagnetic radiation.

Particularly advantageous are composite optical elements that comprise a first glass with a predetermined, particular material property, and a second glass that has a complicated geometry.

It is particularly advantageous for the composite optical element to comprise at least one pressed, in particular blank pressed glass.

As already mentioned above, the composite optical element is designed with particular preference as an array, and consequently comprises a multiplicity of optical elements that are connected in an ordered field to the first optical element, which is preferably designed as a support element.

It is also advantageously possible for further optical elements to be connected to a composite optical element by means of an adhesion promoting layer or adhesive layer. In order to provide protection against external influences, at least one optical element of the composite optical element can advantageously have an anti-scratch coating. An antifog coating can further be provided.

The composite optical element advantageously has one or more layers that are arranged on an optical element or between two optical elements and have a refractive index that reduces the reflectivity.

Furthermore, the invention solves the technical problem by means of a method for connecting at least one first and one second optical element in which the first optical element contains a crystalline material, the second optical element contains a glass, and the crystalline material has a melting point that is above the transformation temperature of the glass, and at least the glass of the second optical element is heated and brought into contact with the crystalline material of the first optical element.

The crystalline material can, for example, comprise a multiplicity of small, irregularly located crystallites. Because of the uniquely defined properties of a crystal, however, the crystalline material advantageously comprises at least one crystal. The crystalline material can also advantageously be designed overall substantially as a monocrystal, thereby enabling the use of anisotropies, that is to say the directional dependence of specific physical, chemical or mechanical properties. For example, the birefringence properties of a monocrystal can be exploited in a targeted fashion.

Preferred crystalline materials have, for example calcium fluoride and/or yttrium aluminum garnet (YAG). These materials are particularly suitable for use in spectroscopy and laser technology.

The method advantageously provides that the glass of the second optical element, at least in the region that is brought into contact with the crystalline material, or the entire second optical element is heated to a temperature at which the viscosity of the second glass, at least in this region, is lower than or equal to the viscosity at which the second glass enters into a permanent, adhesive bond with the crystalline material, in particular lower than or equal to a viscosity of approximately η<10¹⁰ dPa·s, in particular lower than or equal to a viscosity of approximately η<10⁹ dPa·s.

The method provides with particular advantage that in the region in which the glass of the second optical element is brought into contact with the crystalline material of the first optical element said glass of the second optical element substantially assumes the form of the first optical element, at least in a part of this region.

The method can also advantageously have all the abovedescribed refinements of the method for connecting at least one first and one second optical element in the case of which the first optical element contains a first glass, the second optical element contains a second glass, and the first glass has a different transformation temperature Tg1 than the transformation temperature Tg2 of the second glass, and at least the glass of the second optical element is heated, and brought into contact with the glass of the first optical element, the crystalline material of the first optical element substantially taking over the function of the first glass.

Also within the scope of the invention is a composite optical component having at least a first optical element that contains a crystalline material, and a second optical element that contains a glass, in which the melting point of the crystalline material has a higher value than the transformation temperature of the glass, and the glass being connected to the crystalline material along a common surface region with direct formation of a permanent bond to one another, in particular by means of a method as described above.

The crystalline material of the first optical element preferably comprises at least one crystal.

The crystalline material of the composite optical element preferably advantageously has calcium fluoride, in particular CaF₂, and/or yttrium aluminum garnet, in particular Y₃Al₅O₁₂.

For the purpose of optical use, the composite optical element preferably comprises at least one optical element that has a substantially plane, convex, or concave form, at least in a subregion.

With particular preference, at least one optical element of the composite optical element has, at least in a subregion
a substantially spherical form,
a substantially aspheric form,
a substantially faceted form,
substantially a free form that is neither spherical nor aspheric, or
a form whose surface includes diffractive elements.

With particular advantage, the composite optical element comprises at least one pressed, in particular blank pressed glass.

Furthermore, the composite optical element is particularly preferably designed as an array and consequently comprises a multiplicity of optical elements that are connected in an ordered field to the first optical element, which is preferably designed as a support element.

The composite optical element can advantageously also comprise all the advantageous refinements of the abovedescribed composite optical element that has, at least,
a first optical element that contains a first glass with a transformation temperature Tg1, and
a second optical element that contains a second glass with a transformation temperature Tg2,
the transformation temperature Tg1 having a higher value than the transformation temperature Tg2, and
the second glass being connected to the first glass along a common surface region with direct formation of a permanent bond to one another, the first optical element having a crystalline material instead of the first glass.

The invention furthermore solves the technical problem by means of an optical system that comprises at least one optical element, in particular as a constituent of a composite element as described above, and a holder part, in particular a mounting ring, the optical element being connected directly to the holder part along a common surface region with the formation of a permanent connection. The permanent connection is advantageously produced by means of a method in which the glass of the at least one optical element is heated at least in the region of the connecting surface with the holder part to a temperature at which the glass has a viscosity of η<10¹⁰ dPa·s, in particular of η<10⁹ dPa·s.

Also within the scope of the invention is an optical image sensor, an imaging or illuminating optics, an imaging system, a communications terminal, in particular a mobile radio telephone, a PDA or an MDA, a wafer level package, in particular comprising a multiplicity of optical image sensors that have a composite optical element as is described above.

However, the invention is not restricted to these applications, but comprises in addition the use of an inventive composite optical element in any desired, including future, technical apparatus that requires an optical system having at least two optical elements.

The invention is described in more detail below with the aid of preferred embodiments and with reference to the attached drawings, in the case of which identical reference numerals in the drawings denote identical or similar parts, and in which, schematically in each case:

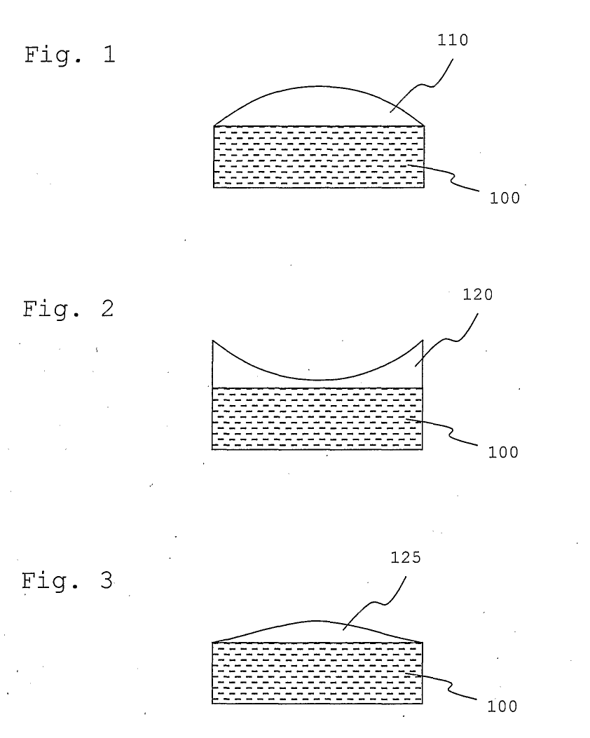

FIG. 1 shows a composite optical element having a planoconvex lens,

FIG. 2 shows a composite optical element having a planoconcave lens,

FIG. 3 shows a composite optical element having an aspheric lens,

FIG. 4 shows a composite optical element having a Fresnel lens,

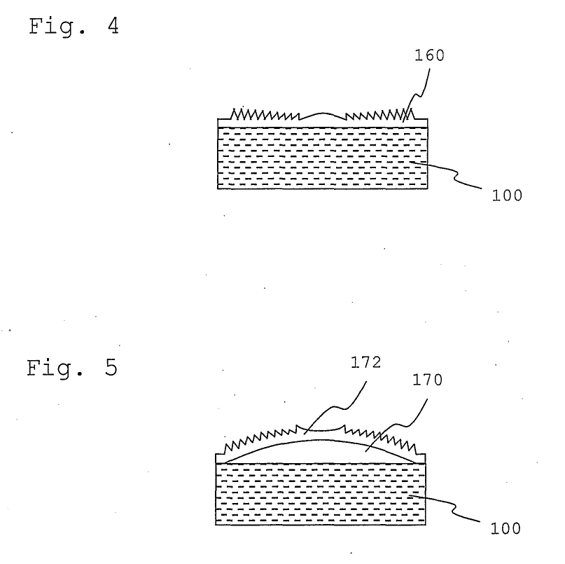

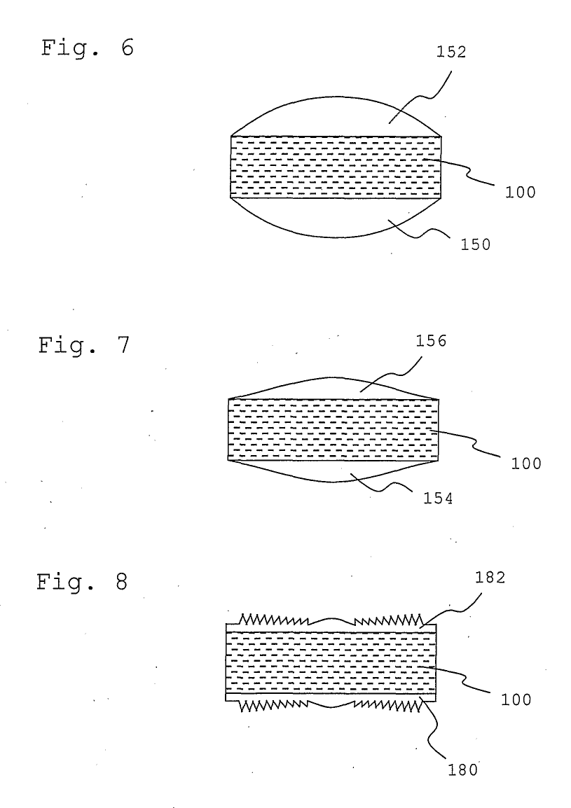

FIG. 5 shows a composite optical element having a planoconvex and a Fresnel lens,

FIG. 6 shows a composite optical element having a two-sided planoconvex lens,

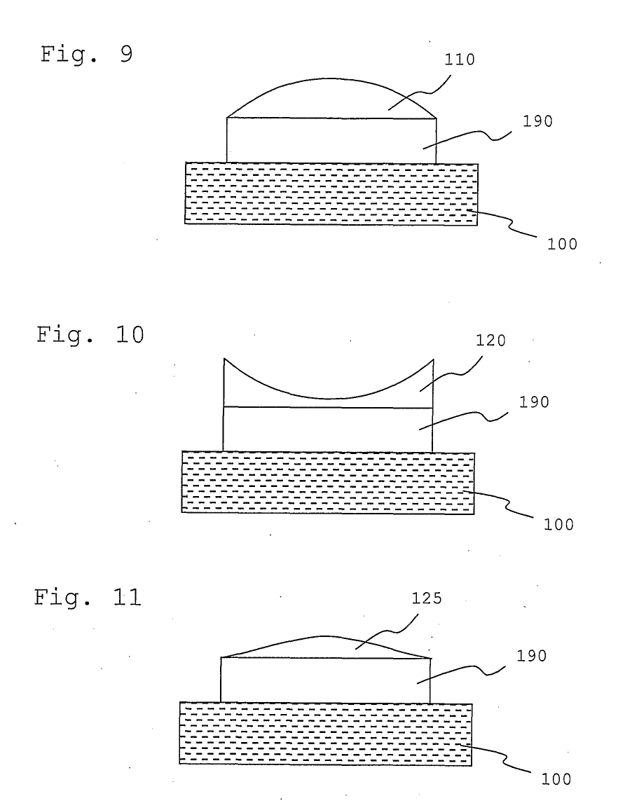

FIG. 7 shows a composite optical element having a two-sided aspheric lens,

FIG. 8 shows a composite optical element having a two-sided Fresnel lens,

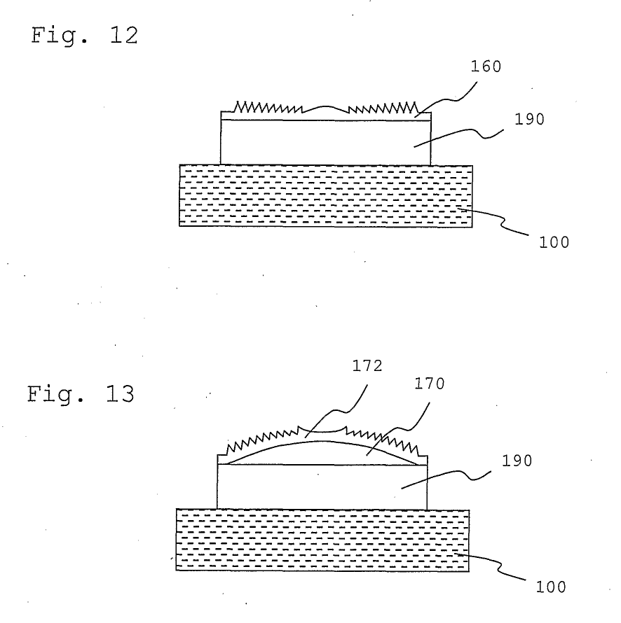

FIG. 9 shows a composite optical element having a parallel-sided plate and a planoconvex lens,

FIG. 10 shows a composite optical element having a parallel-sided plate and a planoconcave lens,

FIG. 11 shows a composite optical element having a parallel-sided plate and an aspheric lens,

FIG. 12 shows a composite optical element having a parallel-sided plate and a Fresnel lens,

FIG. 13 shows a composite optical element having a parallel-sided plate, a parallel convex lens and a Fresnel lens,

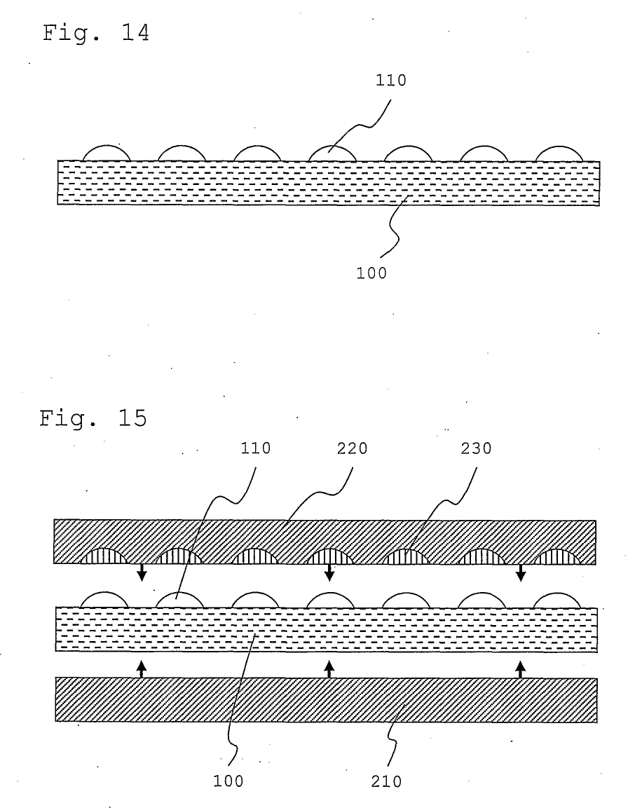

FIG. 14 shows a microlens array having spherical, planoconvex microlenses,

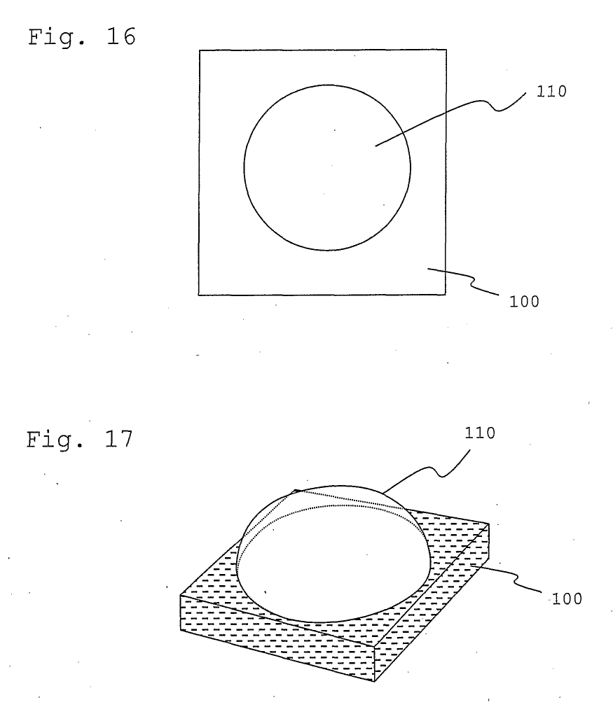

FIG. 15 shows pressing dies for a microlens array,

FIG. 16 shows a plan view of a separated spherical, planoconvex microlens,

FIG. 17 shows a perspective view of a separated spherical, planoconvex microlens,

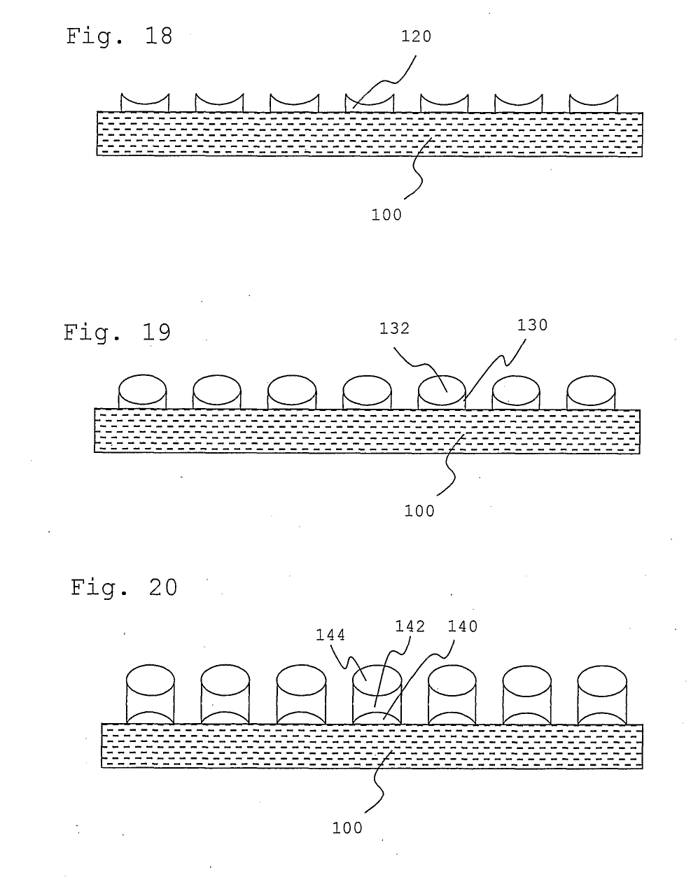

FIG. 18 shows a microlens array having planoconcave microlenses,

FIG. 19 shows a microlens array having systems composed of planoconcave and convex microlenses,

FIG. 20 shows a microlens array having systems composed of planoconvex, concave and convex microlenses,

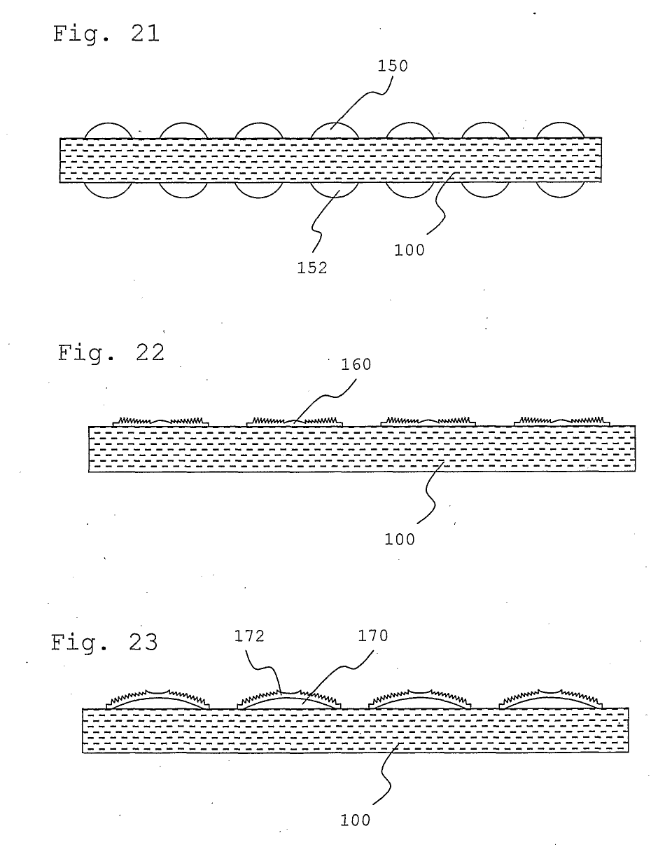

FIG. 21 shows a microlens array having planoconvex microlenses arranged on both sides of the support,

FIG. 22 shows a microlens array having Fresnel microlenses,

FIG. 23 shows a microlens array having systems composed of planoconvex and Fresnel microlenses,

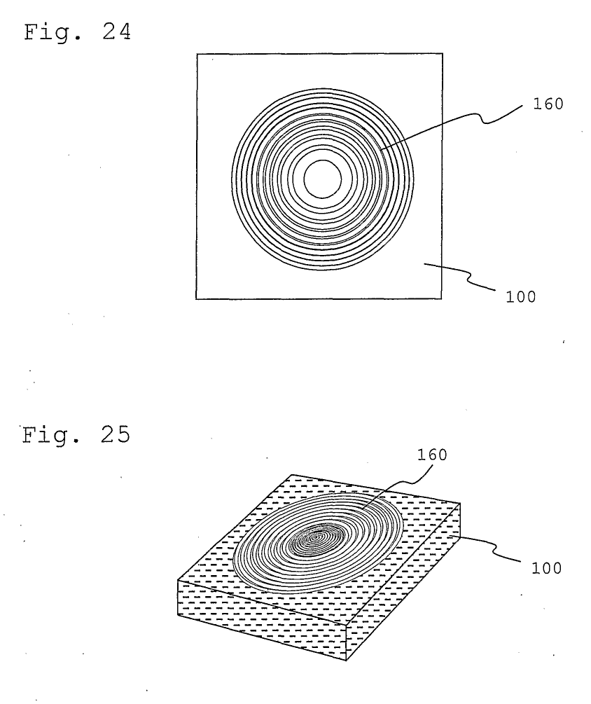

FIG. 24 shows a plan view of a separated Fresnel microlens,

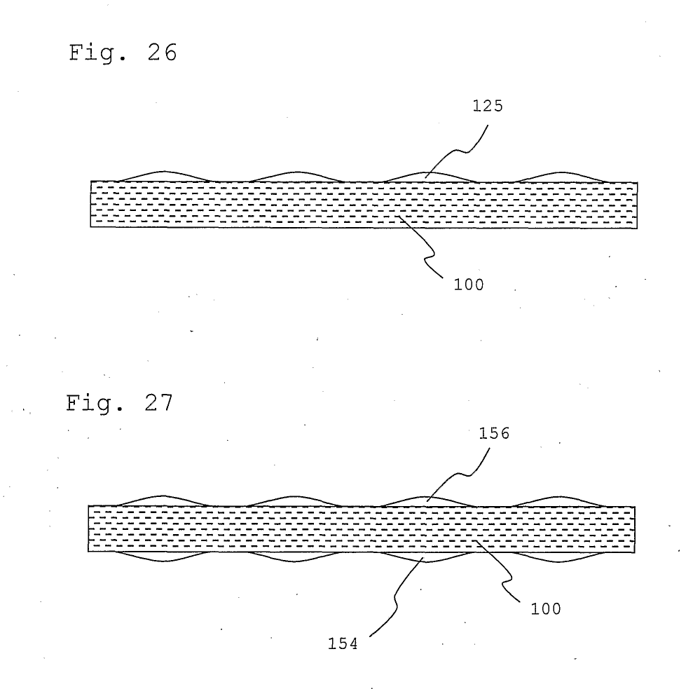

FIG. 25 shows a perspective view of a separated Fresnel microlens,

FIG. 26 shows a microlens array having aspheric microlenses,

FIG. 27 shows a microlens array having aspheric microlenses arranged on both sides of the support,

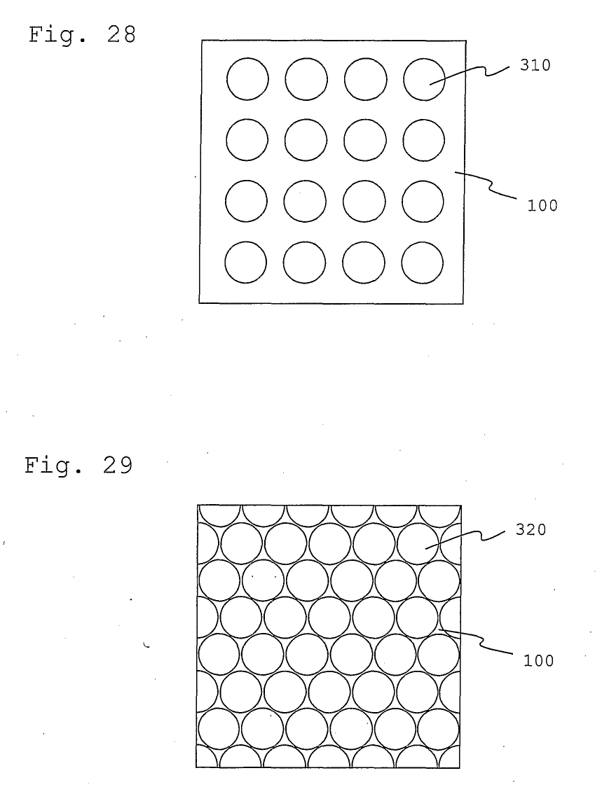

FIG. 28 shows a plan view of a microlens array having microlenses arranged in a row,

FIG. 29 shows a plan view of a microlens array having microlenses arranged in an offset fashion,

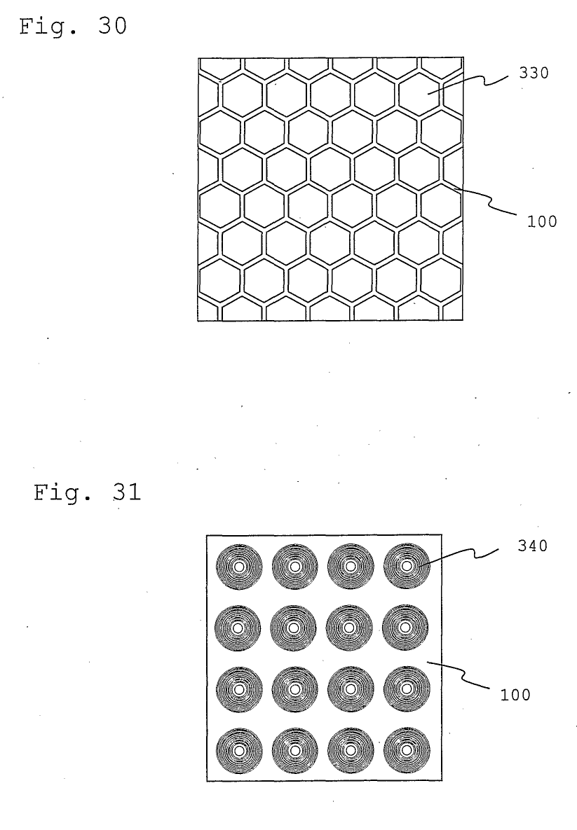

FIG. 30 shows a plan view of a microlens array having hexagonal microlenses,

FIG. 31 shows a plan view of a microlens array having Fresnel microlenses,

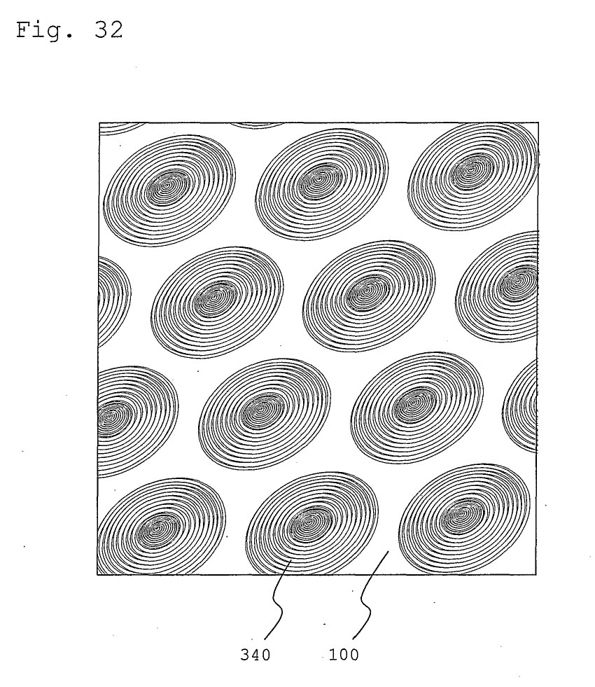

FIG. 32 shows a perspective illustration of a microlens array having Fresnel lenses arranged in an offset fashion,

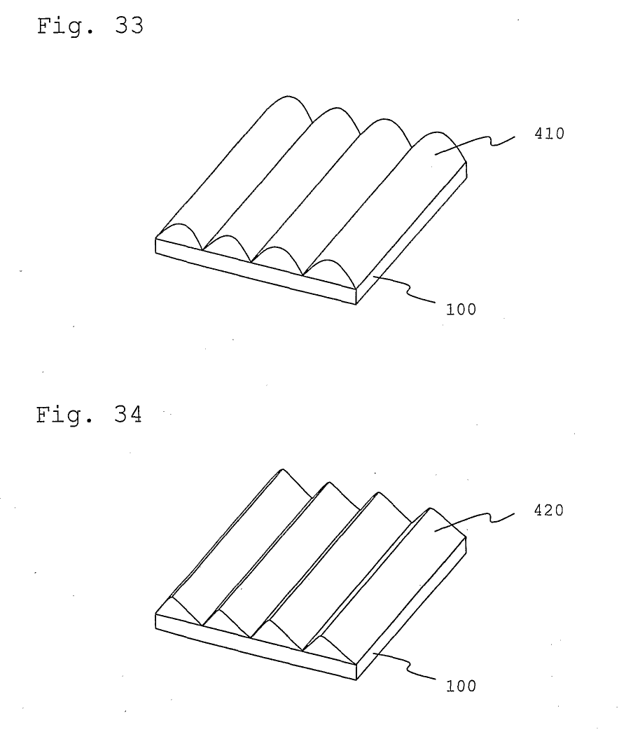

FIG. 33 shows a perspective illustration of a microlens array having cylindrical microlenses,

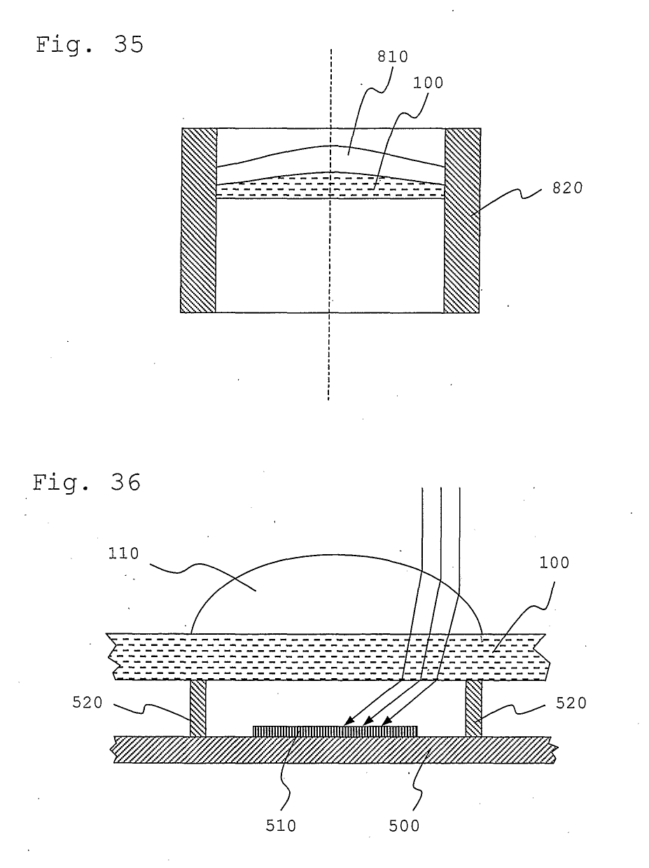

FIG. 34 shows a perspective illustration of a microlens array having asymmetric microlenses,

FIG. 35 shows an optical system having a mounting ring and a composite optical element,

FIG. 36 shows an optical image sensor,

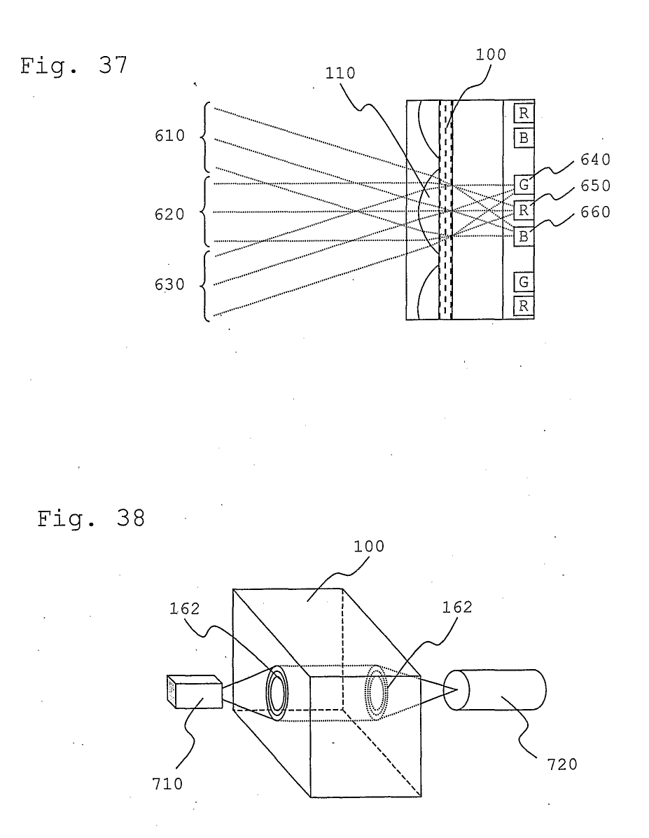

FIG. 37 shows a part of a display device, and

FIG. 38 shows a composite optical element for coupling a laser beam into an optical fiber.

FIGS. 1 to 4 show examples of a composite optical element produced in accordance with the invention and that is designed as hybrid lens and respectively comprises a glass substrate 100 whose glass has a first transformation temperature Tg1. A second optical element is respectively pressed together with the glass substrate with heating, and has a second glass with a transformation temperature Tg2, where Tg2<Tg1. The composite optical element respectively has a second optical element that, upon being pressed on one side, has adopted the plane form of the substrate and, on the other side, the form of the mold. The glass of the second optical element was heated before or during the pressing to a temperature at which it has a viscosity below 10¹⁰ dPa·s, in particular below 10⁹ dPa·s, and has therefore entered into a permanent connection with the glass of the substrate.

In the case of the hybrid lens shown in FIG. 1, the second optical element is designed as a planoconvex lens 110. The hybrid lenses of FIGS. 2, 3 and 4 respectively comprise a second optical element that is designed as a planoconcave lens 120, as an aspheric lens 125 or as a Fresnel lens 160.

FIG. 5 shows a composite optical element having a first optical element in the form of a substrate 100 and a second optical element in the form of a planoconvex lens 170 with the aid of which there is additionally pressed a third optical element 172 that has a third glass having a transformation temperature Tg3, where Tg3<Tg2. The glass of the third optical element 172 was heated before or during the pressing to a temperature at which it has a viscosity below 10¹⁰ dPa·s, in particular below 10⁹ dPa·s and has therefore entered into a permanent connection with the glass of the second optical element 170. In this exemplary embodiment, the third optical element 172 has a form of a Fresnel lens.

FIGS. 6 to 8 each show a composite optical element in the case of which a parallel-sided glass substrate 100 that contains a first glass having a transformation temperature Tg1 is pressed on both sides with in each case an optical element that contains a second glass having a transformation temperature Tg2, Tg2 in turn having a lower value than Tg1. The pressing can in this case preferably be performed on both sides in one work step by using suitable molds.

In the embodiment illustrated in FIG. 6, the optical elements 150 and 152 pressed on both sides have a substantially spherical, planoconvex form. The optical elements 154 and 156 of the embodiment illustrated in FIG. 7 have an aspheric form. In the embodiment shown in FIG. 8, the optical elements 180 and 182 pressed on both sides have the form of a Fresnel lens.

Hybrid lenses having a number of optical elements are illustrated in FIGS. 9 to 13. The first optical element is respectively formed by means of a glass substrate 100. A parallel-sided plate 190 is respectively pressed together with the glass substrate 100. The embodiment in FIG. 9 comprises a third optical element 110 having a planoconvex form that is pressed together with the parallel-sided plate 190. FIGS. 10 to 12 respectively show embodiments in which there are respectively pressed as third optical element a planoconcave lens 120, an aspheric lens 125 and a Fresnel lens 160.

The hybrid lens illustrated in FIG. 13 comprises a third optical element 170 having a planoconvex form, and a fourth optical element in the form of a Fresnel lens.

The glasses of the optical elements have transformation temperatures that respectively rise from the first to the third or fourth optical element, and so it is possible during pressing respectively to set a heating temperature and a pressure in such a way that in each case only one glass is pressed.

FIG. 14 shows a microlens array that is produced by inventively connecting a support glass 100 having a higher transformation temperature Tg1 to a multiplicity of optical elements 110 that have a second glass having a low transformation temperature Tg2.

The principle of the production method is illustrated in FIG. 15. The production method provides for pressing the support glass 100 together with the optical elements 110 by means of a first pressing die, which is plane in this exemplary embodiment, and a second pressing die 220. In this case, the second pressing die has a multiplicity of negative molds 230 inside which a glass gob of the second glass is positioned in each case before the pressing. At least the second pressing die and the glass gob of the second glass that is contained therein are heated by means of a heating device (not illustrated) to a temperature that is above the transformation temperature Tg2 of the second glass, below the transformation temperature Tg1 of the support glass.

FIGS. 16 and 17 respectively show a plan view and a perspective illustration of a microlens, obtained by separation, of the microlens array illustrated in FIG. 14.

FIGS. 18 to 23 and 26 and 27 show further advantageous embodiments of inventively produced microlens arrays in the case of which in each case a multiplicity of microlenses are arranged on a support glass 100.

In the case of the embodiment illustrated in FIG. 18, the microlenses 120 have a planoconcave form. The embodiments of FIGS. 19 and 20 respectively comprise microlens systems consisting of planoconcave 130 and convex 132 microlenses, and of planoconvex 140, concave 142 and convex 144 microlenses.

In the embodiment shown in FIG. 21, the support glass has on both sides a multiplicity of substantially spherical, planoconvex microlenses 150 and 152.

In the embodiment of FIG. 22, the microlenses are designed as Fresnel lenses 160. The microlens array illustrated in FIG. 23 comprises a microlens system consisting of planoconvex microlenses 170 and Fresnel lenses 172.

FIGS. 24 and 25 respectively show a plan view and a perspective illustration of a microlens, obtained by separation, of the microlens array illustrated in FIG. 22.

FIGS. 26 and 27 show microlens arrays having aspheric microlenses 125 arranged on one side, and having aspheric microlenses 154 and 156 arranged on both sides.

FIGS. 28 to 31 show various arrangements of microlenses of a microlens array.

In the arrangement illustrated in FIG. 28, the substantially spherical microlenses 110 are arranged in a row on the support glass 100. An interspace is provided between the individual microlenses, as a result of which separation of the microlenses of the array is simplified.

FIG. 29 shows another arrangement of spherical microlenses 320 in which the microlenses 320 are arranged in offset fashion on a support glass 100. Because of the efficient use of space, such an arrangement can be advantageous for the use of the microlens array in optical image sensors or displays.

The arrangement shown in FIG. 30 has a virtually maximum use of space, owing to hexagonal microlenses 330.

FIG. 31 shows a microlens array having Fresnel microlenses 340 arranged in a row on a support glass 100, while FIG. 32 illustrates a detail of a microlens array in the case of which Fresnel microlenses 340 are arranged in an offset fashion on a support glass 100.

FIGS. 33 and 34 show inventively produced diffractive optical elements (DOE).

In the embodiment illustrated in FIG. 33, cylindrical microlenses 410 are also arranged on a support glass 100, diffractive effects occurring in the visible spectrum owing to their spatial dimensions.

The embodiment illustrated in FIG. 34 has asymmetric microlenses 420 that are arranged on a support glass 100 and form an optical grating.

The glass substrate 100 can, of course, also already be formed as a lens. Again, the spatial dimensions of an inventive hybrid lens can, of course, also lie in another range than the micrometer range of microlenses, for example they can lie in a range of a few centimeters for use in photography.

FIG. 35 shows an optical system as an exemplary embodiment of the invention in the case of which a first optical element 100, formed as an aspheric lens, has been pressed together with a second optical element 810, the second optical element likewise having assumed an aspheric form owing to being pressed. The second optical element is pressed simultaneously with a holder part 820 that is designed in this example as a metal ring for mounting, for example, in a photographic camera.

FIGS. 36 to 38 show various possibilities of using composite optical elements or hybrid elements produced according to the invention, in particular in the form of microlenses or microlens arrays.

FIG. 36 illustrates an optical image sensor that has a CMOS sensor 510 arranged on a substrate 500. A microlens 110, which is arranged on a support glass 100 connected to the substrate 500 via spacing and screening elements 520, serves the purpose of refracting incident light in the direction of the CMOS sensor in order thus to increase the light yield.

FIG. 37 shows a detail from a display device in the case of which color is separated into blue 610, red 620 and green 630 light by means of a dichroic mirror (not illustrated). Microlenses 110 arranged on a support glass 100 serve in this exemplary embodiment to focus the light beams that are illustrated by the display device as RGB pixels 640, 650 and 660.

Illustrated in FIG. 38 is an inventive composite optical element that comprises a support glass 100 which in each case has Fresnel microlenses 162 on opposite sides. The first Fresnel microlens serves in this exemplary embodiment to collimate the light of a laser 710, while the second Fresnel microlens serves the purpose of focusing the light and coupling it into a glass fiber 720.

### LIST OF REFERENCE NUMERALS

100 Glass substrate
110 Convex microlens
120 Concave microlens
125 Aspheric microlens
130, 132 Microlens system
140-144 Microlens system
150, 152 Convex microlenses arranged on both sides
154, 156 Aspheric microlenses arranged on both sides
160, 162 Fresnel microlens
170, 172 Fresnel microlens system
180, 182 Fresnel microlenses arranged on both sides
190 Parallel-sided plate
210 Lower pressing die
220 Upper pressing die
230 Cutout for microlens
310 Microlenses arranged in a row
320 Microlenses arranged in an offset fashion
330 Hexagonal microlenses
340 Fresnel microlenses arranged in a row
410 Cylindrical microlens
420 Asymmetric microlens
500 Silicon substrate
510 CMOS sensor
520 Spacing and screening element
610 Blue light from dichroic mirror
620 Red light from dichroic mirror
630 Green light from dichroic mirror
640-660 RGB pixels
710 Laser
720 Glass fiber
810 Aspheric lens
820 Holder part

1. A method for connecting at least one first and one second optical element, in the case of which
the first optical element contains a first glass,
the second optical element contains a second glass, and
the first glass has a higher transformation temperature Tg1 than the transformation temperature Tg2 of the second glass, the method comprising:
bringing into contact at least the glass of the second optical element with the glass of the first optical element; and
heating the second glass, at least in the region that is brought into contact with the first glass, to a temperature at which the viscosity of the second glass, at least in this region, is lower than or equal to the viscosity at which the second glass enters into a permanent, adhesive bond with the first glass.

2. The method as claimed in claim 1, wherein the second glass, at least in the region that is brought into contact with the first glass, or the entire second optical element is heated to a temperature that is higher than or equal to the transformation temperature Tg2 of the second glass.

3. (canceled)

4. The method as claimed in claim 1, characterized in that the glass of the first optical element, at least in the region with which the glass of the second optical element is brought into contact, or the entire first optical element is heated to a temperature that is higher than or equal to the transformation temperature Tg2 of the second glass.

5. The method as claimed in claim 4, wherein the glass of the first optical element, at least in the region with which the glass of the second optical element is brought into contact, or the entire first optical element is heated to a temperature that is higher than or equal to the transformation temperature Tg2 of the second glass or is lower than the transformation temperature Tg1 of the first glass.

6. (canceled)

7. The method as claimed in claim 4, wherein the glass of the first and of the second optical element is heated while being brought into contact.

8. The method as claimed in claim 1, wherein, during and/or after the process of bringing into contact, there is exerted on at least the second optical element a pressure by means of which a deformation at least of parts of the second optical element is effected.

9. The method as claimed in claim 8, wherein the pressure exerted on at least the second optical element is between 0.01 and 20 N/mm².

10-15. (canceled)

16. The method as claimed in claim 1, wherein in a further region, which is opposite the region in which the glass of the second optical element is brought into contact with the glass of the first optical element, the glass of the second optical element is deformed, at least in a part of this further region.

17-21. (canceled)

22. The method as claimed in claim 16, wherein in the further region the glass of the second optical element assumes a form whose surface includes diffractive elements that have the action of a collecting or scattering lens, or that act in a fashion which is beam splitting, beam shaping, athermal or achromatic, or have some other optical action and/or function.

23. The method as claimed in claim 16, wherein the glass of the second optical element assumes in the further region a form whose surface includes diffractive elements that have the action of a spherical lens.

24. The method as claimed in claim 16, wherein the glass of the second optical element assumes in the further region a form whose surface includes diffractive elements that have the action of an aspheric lens.

25. The method as claimed in claim 1, wherein a third optical element, which comprises a third glass, is brought into contact with at least one of the first and the second optical element, and the transformation temperature Tg3 of the third glass is lower than the transformation temperature Tg2 of the second glass.

26. The method as claimed in claim 25, wherein in the region in which the glass of the third optical element is brought into contact with the glass of the second optical element said glass of the third optical element substantially assumes the form of the second optical element, at least in a part of this region.

27-31. (canceled)

32. The method as claimed in claim 26, wherein in a further region, which is opposite the region in which the glass of the third optical element is brought into contact with the glass of the second optical element, the glass of the third optical element is deformed, at least in a part of this further region.

33-37. (canceled)

38. The method as claimed in claim 32, wherein in the further region the glass of the third optical element assumes a form whose surface includes diffractive elements that have the action of a collecting or scattering lens, or that act in a fashion which is beam splitting, beam shaping, athermal or achromatic, or have some other optical action and/or function.

39. The method as claimed in claim 32, wherein the glass of the third optical element assumes in the further region a form whose surface includes diffractive elements that have the action of a spherical lens.

40. The method as claimed in claim 32, wherein the glass of the third optical element assumes in the further region a form whose surface includes diffractive elements that have the action of an aspheric lens.

41-43. (canceled)

44. The method as claimed in claim 1, wherein at least two of the glasses differ from one another in their dispersion properties.

45. The method as claimed in claim 1, wherein at least two of the glasses differ from one another in their coefficients of thermal expansion.

46. The method as claimed in claim 1, wherein at least one of the glasses is a fluorescent glass.

47. The method as claimed in claim 1, wherein at least two of the glasses differ from one another in their chemical resistance to alkalis or acids.

48. The method as claimed in claim 1, wherein at least one of the glasses has a spectral transmission or coloration that differs from the spectral transmission or coloration of the other glasses.

49-50. (canceled)

51. The method as claimed in claim 1, wherein there is applied to the glass of at least one of the first and the second optical element, at least in the region with which at least one additional glass is brought into contact, a layer that increases the adhesive strength of the at least one additional glass.

52. The method as claimed in claim 1, wherein there are applied to the glass of at least one of the first and the second optical element, at least in the region with which at least one additional glass is are brought into contact, a layer or several layers which have a refractive index that reduces the reflectivity.

53-74. (canceled)

75. A composite optical element, comprising
a first optical element that contains a first glass with the transformation temperature Tg1,
a second optical element that contains a second glass with the transformation temperature Tg2,
the transformation temperature Tg1 having a higher value than the transformation temperature Tg2, and
the second glass being connected to the first glass along a common surface region with direct formation of a permanent bond to one another, in accordance with the method of claim 1.

76. (canceled)

77. The composite optical element as claimed in claim 75, comprising a third optical element which comprises a third glass with a transformation temperature Tg3, the transformation temperature Tg3 of the third glass being lower than the transformation temperature Tg2 of the second glass, and the third glass being connected to the first and/or second glass along a common surface region with direct formation of a permanent bond to one another.

78-89. (canceled)

90. The composite optical element as claimed in claim 75, comprising at least two glasses with different coefficients of thermal expansion.

91. The composite optical element as claimed in claim 90, that comprises at least one glass whose coefficient of thermal expansion corresponds substantially to that of a semiconductor wafer.

92-95. (canceled)

96. The composite optical element as claimed in claim 75, comprising a multiplicity of optical elements connected to the first optical element that are arranged in an ordered field (array).

97-98. (canceled)

99. A method for connecting at least one first and one second optical element, in which the first optical element contains a crystalline material,
the second optical element contains a glass, and
the crystalline material has a melting point that is above the transformation temperature of the glass, the method comprising:
bringing into contact at least the glass of the second optical element with the crystalline material of the first optical element; and
heating the second glass, at least in the region that is brought into contact with the crystalline material, to a temperature at which the viscosity of the glass, at least in this region, is lower than or equal to the viscosity at which the second glass enters into a permanent, adhesive bond with the crystalline material.

100. (canceled)

101. The method as claimed in claim 99, wherein the crystalline material has at least one of calcium fluoride and yttrium aluminum garnet (YAG).

102. (canceled)

103. A composite optical element, comprising
a first optical element that contains a crystalline material, and
a second optical element that contains a glass,
wherein
the melting point of the crystalline material has a higher value than the transformation temperature of the glass, and
the glass being connected to the crystalline material along a common surface region with direct formation of a permanent bond to one another, in accordance with the method of claim 99.

104. (canceled)

105. The composite optical element as claimed in claim 103, wherein the crystalline material has at least one of calcium fluoride and yttrium aluminum garnet (YAG).

106. The composite optical element as claimed in claim 103, comprising at least one optical element that has a substantially plane, convex or concave form at least in a subregion.

107-109. (canceled)

110. A composite optical system, comprising
at least one optical element, and
at least one holder part, in particular a mounting ring, in which
the at least one optical element is directly connected, along a common surface region, to the holder part, with the formation of a permanent connection.

111. (canceled)

112. An imaging or illuminating optics defined by at least one composite optical element that comprises:
a first optical element that contains a crystalline material; and
a second optical element that contains a glass;
wherein the melting point of the crystalline material has a higher value than the transformation temperature of the glass; and
wherein the glass being connected to the crystalline material along a common surface region with direct formation of a permanent bond to one another, in accordance with the method of claim 99.

113. An imaging system defined by at least one composite optical element that comprises:
a first optical element that contains a crystalline material; and
a second optical element that contains a glass;
wherein the melting point of the crystalline material has a higher value than the transformation temperature of the glass; and
wherein the glass being connected to the crystalline material along a common surface region with direct formation of a permanent bond to one another, in accordance with the method of claim 99.

114. A communications terminal, in particular mobile radio telephone, PDA or MDA, defined by at least one composite optical element that comprises:
a first optical element that contains a crystalline material; and
a second optical element that contains a glass;
wherein the melting point of the crystalline material has a higher value than the transformation temperature of the glass; and
wherein the glass being connected to the crystalline material along a common surface region with direct formation of a permanent bond to one another, in accordance with the method of claim 99.

115. A wafer level package, in particular comprising a multiplicity of electronic image sensors, defined by at least one composite optical element that comprises:
a first optical element that contains a crystalline material; and
a second optical element that contains a glass;
wherein the melting point of the crystalline material has a higher value than the transformation temperature of the glass; and
wherein the glass being connected to the crystalline material along a common surface region with direct formation of a permanent bond to one another, in accordance with the method of claim 99.

116-133. (canceled)
